(19) United States
(12) Patent Application Publication
(10) Pub. No.: US 2025/0373568 A1
(43) Pub. Date: Dec. 4, 2025

(54) METHOD AND SYSTEM OF TIME AWARE END-TO-END SERVICE AND BANDWIDTH-ON-DEMAND RESERVATION AND PROVISIONING ACROSS MULTIPLE DOMAINS

(71) Applicant: Tata Communications (America) Inc., Reston, VA (US)

(72) Inventors: Min Sang YOON, Mckinney, TX (US); Ahmad Najib KHALIL, Red Bank, NJ (US); Mohammad NURUJJAMAN, East Brunswick, NJ (US); Ali FOULADGAR, Holmdel, NJ (US)

(21) Appl. No.: 18/871,659

(22) PCT Filed: Apr. 28, 2023
(86) PCT No.: PCT/US2023/020467

§ 371 Date: Dec. 4, 2024

Related U.S. Application Data
(60) Provisional application No. 63/351,408, filed on Jun. 12, 2022.

(51) Int. Cl. H04L 47/785; H04L 41/12; H04L 41/5051; H04L 47/70; H04L 47/80

(52) U.S. Cl. CPC H04L 47/785; H04L 41/12; H04L 41/5051; H04L 47/803; H04L 47/826

(57) ABSTRACT

Disclosed herein are methods and systems for E2E service decomposition to orchestrate and provision services across multiple network domains (a plurality of network domains), and time-aware calendarization. The methods and systems provide time-aware E2E service reservation (e.g., bandwidth allocation) and provisioning across the multiple network domains based on a method and system model that manages the multiple network domains. and methods for verifying and reserving bandwidth and other E2E service reservations.

### RELATED APPLICATION

This application claims the priority benefit of U.S. Provisional Patent Application No. 63/351,408, filed Jun. 12, 2022, the entire disclosure of which is incorporated herein by reference.

### FIELD

The present disclosure relates to connectivity services on a network, and more particularly, to time aware end-to-end service and bandwidth-on-demand reservation and provisioning across multiple domains.

### BACKGROUND

An end-to-end (E2E) service is a service that crosses multiple network domains, from one end of the network to the other end. Service orchestration automates the operations of designing, creating, delivering, and managing E2E, which are mostly performed by service providers. Traditionally, all these operations have been executed by Network Management and domain-specific operational support systems and tools built for static environments.

Service orchestration systems provide solutions for serving the needs of more dynamic and complex service provider environments in modern network industries. Service orchestration systems enable service providers to design their own services and create, deliver, and manage their E2E services through interaction and integration with Operations Support Systems (OSS), Business Support Systems (BSS), Network Management Systems (NMS), Software Defined Networking (SDN) controllers, and/or Network Functions Virtualization orchestrators, through the multiple protocols. Specifically, service orchestration systems provide integrated functionalities required to execute all required operations to design, create, deliver, and manage E2E services such as inventory, design tools, orchestration engines, service path computations, network controllers, data collection & analysis tools, etc.

The service orchestration is positioned between the OSS/BSS layer and network domain layer, to delivery customer's requests to multiple network domains in order to provide E2E connectivity services and manage them. This allows the managing and the delivering of the E2E services based on an integrated database and inventory, however, this creates a heavy workload for the service orchestration system and a high level of infrastructure cost in terms of extensive database management, to capture all network resource states.

### SUMMARY

Disclosed herein are methods and systems for E2E service decomposition to orchestrate and provision services across multiple network domains (a plurality of network domains), and time-aware calendarization. The methods and systems provide time-aware E2E service reservation (e.g., bandwidth allocation) and provisioning across the multiple network domains based on a method and system model that manages the multiple network domains, and methods for verifying and reserving bandwidth and other E2E service reservations.

In various embodiments, an E2E service request for Bandwidth-on-Demand (BoD) is processed by an orchestration system to verify and reserve an E2E service request. The orchestration system manages a service computer database and a service usage database, which together stores provisioned services and reserved bandwidth for these services including the E2E route of the provisioned services. When a BoD request is received at the orchestrator, an orchestration engine of the orchestrator verifies if the request can be reserved along the paths of the E2E service for the requested time based on network topology and resource availability stored in a network topology and resource computer database of the orchestrator. If the request is feasible along the paths of all of the network domains, the bandwidth is reserved through a scheduler of the orchestrator and subsequently, the orchestration engine updates a service reservation computer database of the orchestrator with service reservation information. The scheduler triggers the orchestration engine to perform a service update for the BoD, then the orchestration engine executes a process that uses service reservation data from service reservation computer database and sends service provisioning requests to the corresponding network domain controllers, to update the service following the BoD request.

The method and system comprises an orchestration engine that reserves and validates E2E requests, such as bandwidth allocation, by parsing the endpoints of the E2E service request and decomposes it to multiple subservice requests and sends subservice path computation requests to network domain controllers of each network domain for each subservice request. The orchestration engine performs a feasibility check to verify the availability of the list of subservice paths calculated from the network domain controllers based on the live data stored in an orchestrator database, then generates a list of available/feasible subservice paths in each network domain. Subservice paths are typically paths from node a, to node b, to node c, etc. in a network domain, like any path in any networking system. There can be multiple ways to go from node a to node c, instead of going through node b (2 hops), as mentioned above. For example, the subservice path can comprise node a, to node d, to node f, and to node c. Such a subservice path provides the same E2E, path, but one with 3 hops. The E2E service path is then designed by the orchestration engine to build a circuit by aggregating verified paths and the feasibility check results of each network domain controller.

Unlike the existing systems which perform E2E service path calculation based on its own database and path computation engine, the method and system of the present disclosure distributes the computation of the E2E service path and reduces the workload of the orchestration system and maintains a lightweight orchestrator database, which includes only essential information of the network resources. In particular, real time network resource and service information is maintained in the orchestrator database of the present disclosure, but the orchestrator database does not need to maintain full specifications of network resources because the subservice paths are calculated by the network domain controllers. In various embodiments of the present disclosure provide database schema structure that manages the time aware network management resources and service reservations to support time aware E2E service and Bandwidth-on-Demand (BoD) reservations.

In some embodiments, the method for time aware end-to-end (E2E) service orchestration across a plurality of network domains of a communication network, comprises: receiving at an orchestrator computing device, a request for a E2E service at a requested time; determining with the orchestrator computing device, whether the E2E service is across the plurality of network domains; if the E2E service is across more than one of the plurality of network domains, decomposing with the orchestrator computing device, the E2E service into a plurality of subservices, the plurality of subservices designated for the more than one of the plurality of network domains; determining in a time aware manner with the orchestrator computing device, the availability of bandwidth for each of one or more paths that have been calculated for each of the subservice paths across their designated network domains, at the requested time; if bandwidth is available for one of the one or more service paths at the requested time in each of the network domains having a subservice designated thereto, designing with the orchestrator computing device a E2E circuit path based on the available one or more service paths in each of the network domains having a subservice designated thereto; and provisioning, with the domain controller computing devices of the network domains having the subservices designated thereto, the plurality of subservices of the E2E service, in response to a provisioning request from the orchestrator computing device.

In some embodiments, the determining of whether the E2E service is across the plurality of network domains comprises: finding one of the plurality of network domains; determining whether a first endpoint of the E2E service belongs to the found one of the plurality of network domains; determining whether a second endpoint of the E2E service belongs to the found one of the plurality of network domains; and if the first endpoint belongs to the found one of the plurality of network domains and the second endpoint does not belong to the found one of the plurality of network domains, then the E2E service is across the plurality of network domains.

In some embodiments, a record of network-to-network interface (NNI) ports of the plurality of network domains is stored in a database, and wherein the decomposing of the E2E service comprises: a. determining for each of the NNI ports of a selected one of network domains, whether there is an NNI-connection that connects that NNI port to another one of the network domains; b. if there is an NNI-connection that connects that NNI port of the selected one of the network domains to an NNI port of the unvisited network domain, classifying that NNI-connection as belonging to both network domains, wherein the network domains connected by the NNI-connection perform a subservice of the E2E service; and c. repeating a and b for each of the network domains.

In some embodiments the method further comprises requesting with the orchestrator computing device, that a domain controller computing device of each network domain of the plurality of network domains having a subservice designated thereto, perform the calculating of the one or more paths for that subservice across its designated network domain.

In some embodiments, the determining of the availability of bandwidth for each of the one or more paths comprises: using service usage, network topology and resource, service reservation data, and their relationships to one another stored in at least one computer database to verify the availability of bandwidth for each of the one or more paths at the requested time.

In some embodiments, the determining of the availability of bandwidth for each of the one or more paths comprises: for each of the designated network domains, selecting a path from the one or more paths associated therewith and comparing other services running on that designated network domain at the same time that the subservice is requested to be running on that network domain to determine if bandwidth is available for that subservice at the requested time, wherein data about the other services running on the designated network domains is obtained by the orchestrator computing device from at least one computer database.

In some embodiments, before provisioning the plurality of subservices, the method further comprises: determining whether the E2E service is for a future time; if the E2E service is for a future time, updating data in a service reservation computer database; scheduling the E2E service through a scheduler; and with the scheduler, causing the orchestrator computing device to request the provisioning of the plurality of subservices of the requested E2E service.

In some embodiments, before provisioning the plurality of subservices, the method further comprises: determining whether the E2E service is for a future time; and if the E2E service is for an immediate time, requesting the provisioning of the plurality of subservices of the requested E2E service.

In some embodiments, if the E2E service is across only one of the plurality of network domains: determining in the time aware manner with the orchestrator computing device, the availability of bandwidth for each of one or more paths calculated for the E2E service across the only one of the plurality of network domains, at the requested time; if bandwidth is available for one of the one or more service paths at the requested time in the only one of the plurality of network domains, designing with the orchestrator computing device a E2E circuit path based on the available one or more service paths in the only one of the plurality of network domains; and provisioning, through the domain controller computing device of the only one of the plurality of network domains, the plurality of subservices of the E2E service in response to a request from the orchestrator computing device.

In some embodiments, the orchestration system comprises: a plurality of network domains of a communication network, each of the plurality of network domains have at least one network-to-network interface (NNI) port and a domain controller computing device, each of the domain controller computing devices configured for provisioning E2E services and subservices; an orchestrator computing device for time aware end-to-end (E2E) service orchestration across the plurality of network domains; the orchestrator computing device configured to: receive a request for a E2E service at a requested time; determine whether the E2E service is across the plurality of network domains; decompose the E2E service into a plurality of subservices if the E2E service is across more than one of the plurality of network domains, the plurality of subservices designated for the more than one of the plurality of network domains; determine in a time aware manner the availability of bandwidth for each of one or more paths that have been calculated for each of the subservice paths across their designated network domains, at the requested time; design a E2E circuit path if bandwidth is available for one of the one or more service paths at the requested time in each of the network domains having a subservice designated thereto, the E2E circuit path based on the available one or more service paths in each of the network domains having a subservice designated thereto; and request the domain controller computing devices of the network domains having the subservices designated thereto, provision the plurality of subservices of the E2E service in response.

In some embodiments, the orchestration computing device is configured to determine whether the E2E service is across the plurality of network domains by: finding one of the plurality of network domains; determining whether a first endpoint of the E2E service belongs to the found one of the plurality of network domains; determining whether a second endpoint of the E2E service belongs to the found one of the plurality of network domains; and if the first endpoint belongs to the found one of the plurality of network domains and the second endpoint does not belong to the found one of the plurality of network domains, then the E2E service is across the plurality of network domains.

In some embodiments, the orchestrator computing device includes a database for storing a record of the network-to-network interface (NNI) ports of the plurality of network domains, and wherein the orchestrator computing device is configured to decompose the E2E service by: a. determining for each of the NNI ports of a selected one of network domains, whether there is an NNI-connection that connects that NNI port to another one of the network domains; b. if there is an NNI-connection that connects that NNI port of the selected one of the network domains to an NNI port of the unselected network domain, classifying that NNI-connection as belonging to both network domains, wherein the network domains connected by the NNI-connection each perform a subservice of the E2E service; and c. repeating a and b for each of the network domains.

In some embodiments, the orchestrator computing device is configured to request that the domain controller computing device of each network domain of the plurality of network domains having a subservice designated thereto, perform the calculation of the one or more paths for that subservice across its designated network domain.

In some embodiments, the orchestrator computing device includes at least one database for storing service usage, network topology and resource, service reservation data, and their relationships to one another, wherein the orchestrator computing device is configured to determine the availability of bandwidth for each of the one or more paths comprises using the service usage, network topology and resource, service reservation data, and their relationships to one another stored in the at least one computer database, to verify the availability of bandwidth for each of the one or more paths at the requested time.

In some embodiments, the orchestrator computing device includes at least one database for storing data about services of other requests running on the designated network domains, wherein the orchestrator computing device is configured to determine the availability of bandwidth for each of the one or more paths for each of the designated network domains by selecting a path from the one or more paths associated therewith and comparing the services of the other requests running on that designated network domain at the same time that the subservice is requested to be running on that network domain to determine if bandwidth is available for that subservice at the requested time.

In some embodiments, the orchestrator computing device includes a service registration database and a scheduler, wherein before provisioning the plurality of subservices, the orchestrator computing device is configured to: determine whether the E2E service is for a future time; if the E2E service is for a future time, update data in the service reservation computer database; and schedule the E2E service through a scheduler; wherein the scheduler is configured to cause the orchestrator computing device to request the provisioning of the plurality of subservices of the requested E2E service.

In some embodiments, before provisioning the plurality of subservices, the orchestrator computing device is configured to: determine whether the E2E service is for a future time; and if the E2E service is for an immediate time, request that the domain controller computing devices provision the plurality of subservices of the requested E2E service.

In some embodiments, if the E2E service is across only one of the plurality of network domains, the orchestrator computing device is configured to: determine in the time aware manner, the availability of bandwidth for each of one or more paths calculated for the E2E service across the only one of the plurality of network domains, at the requested time; and if bandwidth is available for one of the one or more service paths at the requested time in the only one of the plurality of network domains, design an E2E circuit path based on the available one or more service paths in the only one of the plurality of network domains; wherein the domain controller computing device of the only one of the plurality of network domains, provisions the plurality of subservices of the E2E service in response to a request from the orchestrator computing device.

In some embodiments, the method and system can be partially implemented using open-source platform, such as Open Network Automation Platform (ONAP). Such an implementation can achieve E2E service orchestration of layer 2 (E-Line) service.

### BRIEF DESCRIPTION OF THE DRAWING

The disclosure is best understood from the following detailed description when read in conjunction with the accompanying drawing. It is emphasized that, according to common practice, the various features of the drawing are not necessarily to scale. On the contrary, the dimensions of the various features may be arbitrarily expanded or reduced for clarity. Like numerals denote like features throughout the specification and the drawing.

FIG. 1 is a block diagram that depicts the architecture of a multi-domain service orchestration system according to an exemplary embodiment of the present disclosure.

FIG. 2 is a block diagram that depicts the components of the orchestration engine of FIG. 1, according to an exemplary embodiment of the present disclosure.

FIGS. 3A and 3B is a flow chart that depicts the operation of the orchestration system of FIG. 1, according to an exemplary embodiment of the present disclosure.

FIG. 4 is a flow chart that depicts the service decomposition method performed by the decomposition component of the orchestration engine of FIG. 2, according to an exemplary embodiment of the disclosure.

FIG. 5 is a flow chart that depicts the time aware service request verification method performed by the bandwidth calculator component of the orchestration engine of FIG. 2, according to an exemplary embodiment of the disclosure.

### DETAILED DESCRIPTION

It should be understood that the phraseology and terminology used below for the purpose of description and should not be regarded as limiting. The use herein of the terms “comprising,” “including,” “having,” “containing,” and variations thereof are meant to encompass the structures and features recited thereafter and equivalents thereof as well as additional structures and features. Unless specified or limited otherwise, the terms “attached,” “mounted,” “affixed,” “connected,” “supported,” “coupled,” and variations thereof are used broadly and encompass both direct and indirect forms of the same.

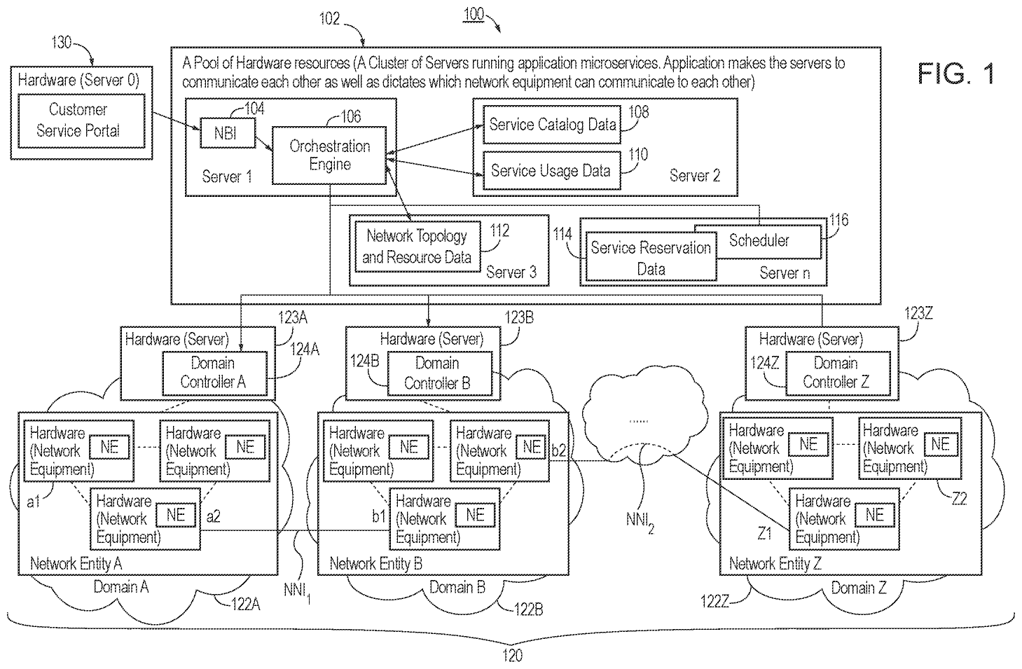

FIG. 1 is a block diagram that depicts the architecture of a multi-network domain service orchestration system according to an exemplary embodiment of the present disclosure, denoted by reference character 100. As depicted, the orchestration system 100 comprises an orchestrator 102, a customer service portal 130, and a communication network 120 comprising a plurality of communication network domains 122A-Z. Each of the network domains 122A-Z includes a network domain controller 124A-Z and a network entity A-Z that comprises various network equipment NE. The network equipment NE used by each of the network entities A-Z can be of a different type from a different vendor and/or different technology, etc. The customer service portal 130 is implemented on a server 0 or other computing device, and allows a customer to access the orchestrator 102 and submit E2E service requests. The various network equipment NE and network domain controller 124A-Z of each network domain 122A-Z can be implemented on a server 123A-Z or other computing device. The network domain controllers A-Z can be SDN (software defined networking) controllers, also referred to as SDN-C or domain controllers. Each of the network domain controllers 124A-Z includes an appropriate application that is configured to control access to its respective network domain 122A-Z and a path computation engine.

Referring still to FIG. 1, the orchestrator 102 can be implemented on a cluster of servers or other computing devices, for example, servers 1, 2, 3, and n. The cluster of servers or other computing devices run application microservices. The orchestrator 102 enables these servers 1, 2, 3, n to communicate with each other and manages each of the plurality of network domains 122A-Z of the communication network 120 by determining which network equipment NE of the network domains 122A-Z can communicate with each other. Specifically, since the orchestrator 102 builds the E2E service path, the orchestrator 102 determines what network equipment NE in, for example, network domain 122A communicates with network equipment NE in network domain 122B and so forth, in order to build a service path across multiple network domains 122A-Z over NNIs (network-to-network interfaces) or in other words, how the network domains 122A-Z are connected to one another. The orchestrator 102 effectively manages the network domain controllers 124A-Z because it instructs them to perform certain tasks, i.e., compute a subservice path for a specific subservice request within the domain itself, but it doesn't dictate how the subservice path within the domain is constructed.

Referring still to FIG. 1, the orchestrator 102 comprises a northbound interface (NBI) 104, an orchestration engine 106, a computer database 108 for storing service catalog data of various services (e.g., a point-to-point dedicated bandwidth service catalog wherein “bandwidth” is defined herein as the data transfer capacity of a communication network element, a point-to-point with uncommitted bandwidth with best effort CoS service, and/or an internet IP-based service with standard service-level-agreement (SLA) or with a premium SLA), a computer database 110 for storing service usage data (resources used by a particular service, e.g., how much bandwidth is being used, what ports are being used for what services, etc.), a computer database 112 for storing network topology and resource data, a computer database 114 for storing service reservations, and a scheduler 116. The NBI 104 and orchestration engine 106 can be implemented on server 1. The computer database 108 for storing service catalog of various services and the computer database 110 for storing service usage can be implemented on server 2. The computer database 112 for storing network topology and resources can be implemented on server 3. The computer database 114 for storing service reservations, and the scheduler 116 can be implemented on server n.

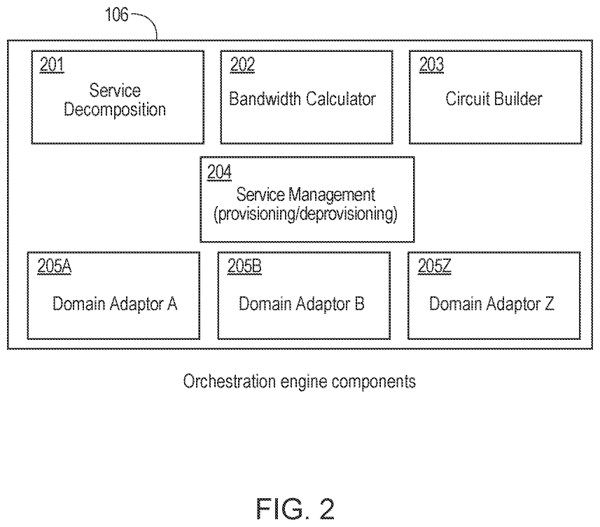

FIG. 2 is a block diagram that depicts the components of the orchestration engine 106 of FIG. 1, according to an exemplary embodiment of the present disclosure. As depicted, the orchestration engine 106 includes a service decomposition component 201, a bandwidth calculator component 202, a circuit builder component 203, and a service management component 204. The orchestration engine 106 also includes a plurality of network domain adaptors 205A-Z, which enable the orchestration engine 106 to interface with and communicate with the network domain controllers 124A-Z of the network domains 122A-Z (FIG. 1). The orchestration engine 106 (including the service decomposition component 201, the bandwidth calculator component 202, the circuit builder component 203, the service management component 204, and the network domain adaptors 205A-Z) can comprise machine-readable instructions (e.g., one or more software modules) which, when executed by server 1 or one or more processors/processing units, performs any of the described functionalities. The machine-readable instructions can be stored on one or more electronic memory devices, hard disks, optical disk or other machine-readable storage mediums or non-transitory mediums.

Referring to FIGS. 1 and 2, the orchestrator 102 provides time aware End-to-End (E2E) service orchestration across the plurality of network domains 122A-Z. In particular, the service decomposition component 201 of the orchestration engine 106 is configured to analyze the endpoints of the E2E service request and decompose to multiple network domains. As used herein, the term “decomposed to multiple network domains” or “decomposed to a plurality of network domains” refers to dividing the E2E service request into subservice requests and sending each of the subservice requests to the network domain 122A-Z that is designated for handling the subservice in the subservice request. In other words, the E2E request is decomposed or divided into subservices by the service decomposition component 201 where each subservice belongs to or is designated for one of the network domains 122A-Z. The service decomposition component 201 then sends multiple path computation requests to the network domain controllers 124A-Z of the network domains 122A-Z via the corresponding network domain adaptors 205A-Z of the orchestration engine 106. The bandwidth calculator component 202 of the orchestration engine 106 performs a feasibility check to verify the bandwidth availability for requested date and time window among the list of paths calculated from each of the network domain controllers 124A-Z based on updated resource data stored in the network topology and resource computer database 112, then generates a list of feasible paths in each of the network domains A-Z. An E2E service path is then designed by the circuit builder component 203 of the orchestration engine 106 by aggregating the verified paths and feasibility check result of each of the network domain controllers 124A-Z to build the E2E service.

Depending on the service request start date and time window, which can be immediate or a future time, the service management component 204 of the orchestration engine 106 can reserve or provision the service request. If the request is an immediate request, the service management component 204 of the orchestration engine 106 sends the provisioning requests to each network domain controller 124A-Z through the network domain adaptors 205 A-Z of the orchestration engine 106. If the request is a future request, the service management component 204 of the orchestration engine 106 makes a reservation in scheduler 114 to commence service provisioning at the requested future time.

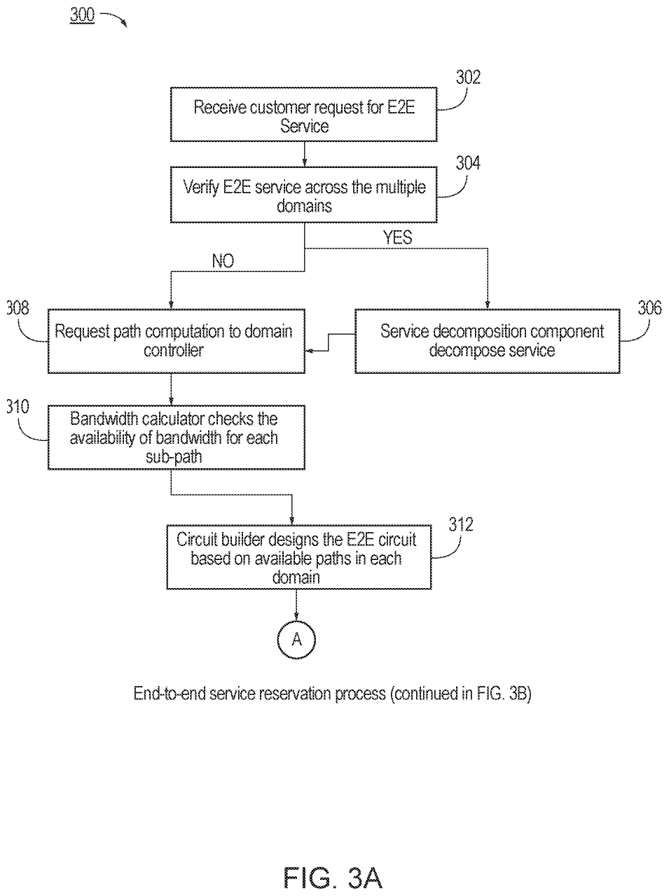

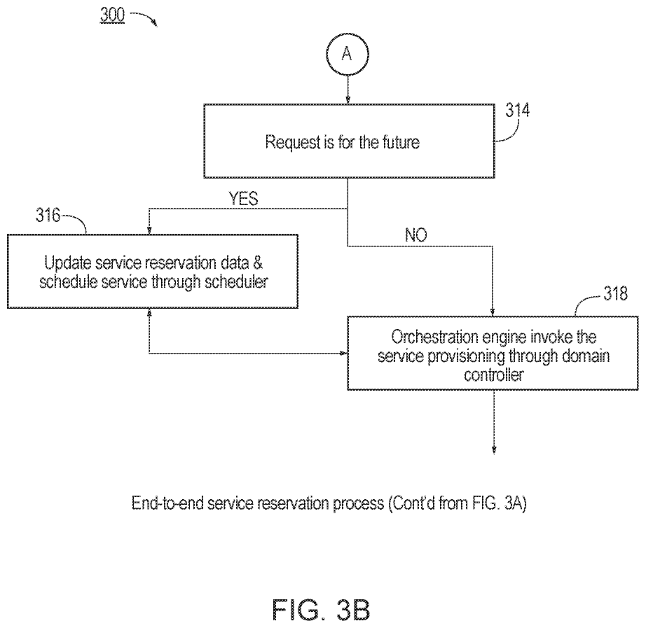

FIGS. 3A and 3B is a flow chart that depicts the operation of the orchestration system 100 according to an exemplary embodiment of the present disclosure. Referring first to FIG. 3A, when a customer submits on the customer portal 130 (FIG. 1) a E2E service request with an immediate or future start time, the NBI 116 (FIG. 1) of the orchestration system 100 (FIG. 1) communicates the E2E service request to the orchestration engine 106 (FIG. 1) in step 302.

In response to the E2E service request, the orchestration engine 106 (FIG. 1) verifies in step 304 of FIG. 3A, whether the E2E service of the request is across multiple ones of the network domains 122A-Z (FIG. 1). If the E2E service is across multiple ones of the network domains 122A-Z, then the method flows to step 306 of FIG. 3A, wherein the service decomposition component 201 (FIG. 2) of the orchestration engine 106 (FIG. 1) decomposes the E2E service to multiple domains according to a service decomposition method performed by the service decomposition component 201 of the orchestration engine 106, and provides service decomposition based on real time data in the network topology and resource computer database 112. When the E2E service request is received by the orchestration engine 106, the decomposition component 201 of the orchestration engine 106 verifies whether the E2E service is required to be decomposed to multiple ones of the network domains 122A-Z. More specifically, when the E2E service request is received by the orchestration engine 106, the decomposition component 201 of the orchestration engine 106 analyzes the E2E service request to determine whether it needs to be divided into multiple subservice requests that require different network domains 122A-Z to perform the subservices. In accordance with the decomposition method, the service decomposition component 201 of the orchestration engine 106 parses the E2E service into multiple subservice requests based on the network topology and resource data stored in the network topology and resource computer database 112.

Referring again to FIG. 1, unlike the traditional service decomposition methods that require full description and information of the network domains including network interfaces, links, and connections, the decomposition method of the present disclosure finds edge interfaces, i.e., the edge points that belong to the network entity of each of the network domains 122A-Z e.g., edge points a1 and a2 in network domain 122A, edge points b1 and b2 in network domain 122b, and edge points z1 and z2 in network domain 122Z. Each edge point includes a UNI (user network interface) port and an NNI (network-to-network interface) port. The UNI port represents a demarcation point that connects the service from the customer or in other words an interface that faces the customer. The NNI port is a reference point representing a boundary between network domains or in other words, an interface that faces another network domain. In FIG. 1, the NNI port of edge point a2 of network domain 122A is connected to the NNI port of edge point b1 of network domain 122B by NNI-connection NNI₁, and the NNI port of edge point b2 of network domain 122B is connected to the NNI port of edge point z1 by NNI-connection NNI₂. If, for example, the E2E service crosses network domains 122A, 122B, and 122Z, the decomposition method decomposes the service to edge points a1 and a2 in network domain 122A, edge points bland b2 in network domain 122B, and edge points z1 and z2 in network domain 122Z. The E2E service in this example would be a1-z2 and the two endpoints of the E2E service would be a1 and z2. The found edge points a1, a2, b1, b2, z1, z2 connect the two endpoints a1 and z2 of the E2E service across the multiple network domains 122A-Z to connect the two endpoints a1 and z2 of the E2E service with information of the network interface resources in each of the network domains 122A-Z. The decomposition method divides the E2E service request into multiple subservice requests with the information of the edge points in each of the network domains 122A-Z (edge points a1 and a2 of network domain 122A, edge points b1 and b2 of network domain 122B, and edge points z1 and z2 of network domain 122Z). The database 112 for storing network topology and resource data, contains NNI data for the network domains 122A-Z. Therefore, the decomposition method determines which NNI ports of one of the network domains 122A-Z is connected to which NNI ports of another one of the network domains 122A-Z and utilize this information to decompose the E2E service of the E2E service request.

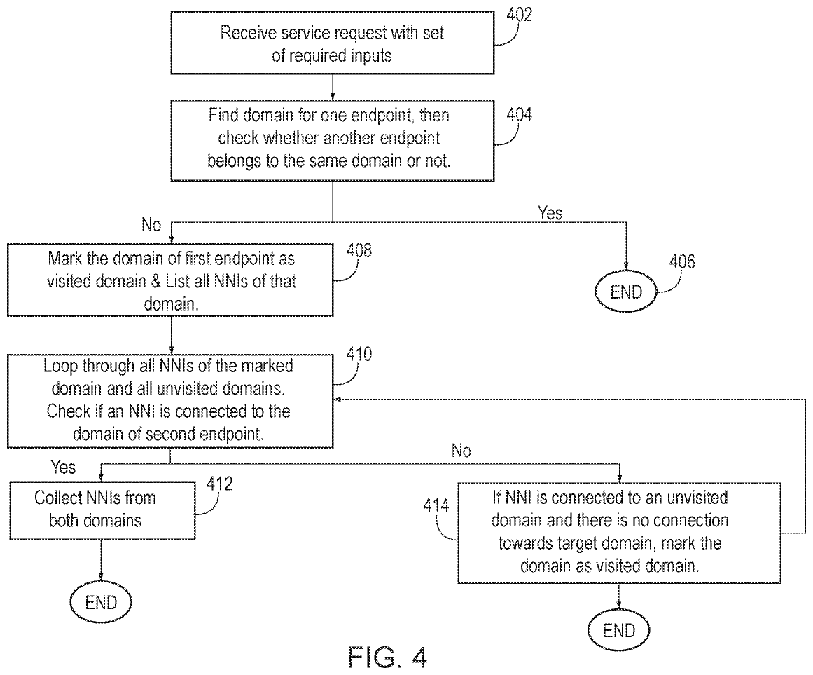

FIG. 4 is a flow chart that depicts the service decomposition method performed by the decomposition component 201 of the orchestration engine 106 in step 306 of FIG. 3A, according to an exemplary embodiment of the disclosure. In step 402 of FIG. 4, the decomposition component 201 of the orchestration engine 106 (FIG. 1) receives the E2E service request with a set of required inputs. The set of required inputs includes first and second endpoints of the E2E service request, a service profile (e.g., bandwidth profile) of the E2E service request, a start time of the E2E service request and an end time of the E2E service request. In step 404 of FIG. 4, the decomposition component 201 uses the service catalog data and network topology data stored in computer databases 108 and 112 to determine whether the E2E service request requires parsing by finding the network domain (of the set of network domains) that a first E2E service endpoint belongs to and then determining whether a second E2E service endpoint belongs to the found network domain. If the first and second E2E service endpoints both belong to the found network domain, the E2E service request does not need to be parsed and the method ends at step 406. For example, if the first E2E service endpoint in the embodiment of FIG. 1 is al of network domain 122A and the second endpoint of the E2E service is a2 of network domain 122A, then the E2E service does not require parsing. However, if the first E2E service endpoint belongs to the found network domain and the second E2E service endpoint does not belong to the found network domain, the E2E service requires parsing and the method flows to step 408 of FIG. 4, wherein the decomposition component 201 commences decomposing the E2E service by marking the found network domain of the first E2E service endpoint as a visited network domain and listing all the NNIs of that network domain. For example, if the first E2E service endpoint in the embodiment of FIG. 1 is al of network domain 122A and the second endpoint of the E2E service is z2 of network domain 122Z, then the E2E service requires parsing. Therefore, network domain 122A is marked as a visited network domain and all the NNI ports of network domain 122A listed in an NNI list for network domain 122A. The list of NNI ports is created by the decomposition component 201 by searching in the database 112 for all the NNI ports that are located in the visited network domain of the first E2E service endpoint. In step 410 of FIG. 4, the decomposition component 201 first iterates through the NNI ports in the list of NNI ports of the visited network domain and then iterates through the NNI ports of the unvisited network domains. This process retrieves all unvisited network domains and determines which of these unvisited network domains are required for the subservices. When the decomposition component 201 iterates through the NNI ports of the visited network domain, for each of these NNI ports (e.g., a1 and a2 of visited network domain 122A of FIG. 1) the decomposition component 201 determines whether there is an NNI-connection that connects that NNI port to an unvisited network domain (e.g., network domain 122B of FIG. 1). If there is an NNI-connection that connects that NNI port of the visited network domain to an NNI port of an unvisited network domain (e.g., NNI-connection NNI1 connecting NNI port a2 of visited network domain 122A with NNI port b1 of unvisited network domain 122B in FIG. 1), the decomposition component 201 classifies that NNI-connection as belonging to both network domains (the visited network domain of the first endpoint and the unvisited network domain) and that NNI-connection is collected by the decomposition component 201 with other such NNI-connections in step 412. When the decomposition component 201 iterates through the NNI ports of each of the unvisited network domains, for each of these NNI ports (e.g., b1 and b2 of unvisited network domain 122B of FIG. 1), the decomposition component 201 determines whether there is an NNI-connection that connects that NNI port to another unvisited network domain (e.g., unvisited network domain 122Z in FIG. 1). If there is an NNI-connection that connects that NNI port of the unvisited network domain to an NNI port of another unvisited network domain (e.g., NNI-connection NNI2 connecting NNI port b2 of unvisited visited network domain 122B with NNI port z1 of unvisited network domain 122Z in FIG. 1), the decomposition component 201 classifies that NNI-connection as belonging to both network domains and that NNI-connection is collected by the decomposition component 201 with other such NNI-connections in step 412. When the decomposition component 201 reaches the unvisited network domain with the second E2E endpoint and finds it (e.g., unvisited domain 122Z in FIG. 1), the decomposition component 201 backtracks through all the NNI ports it passed through to reach the network domain with the second E2E endpoint (e.g., a1, a2, b1, b2, z1, z2 in FIG. 1) and stitches or connects them together, thus distributing the subservices of the E2E service across only the required ones of the multiple network domains. If the decomposition component 201 analyzes the NNI ports of an unvisited network domain and determines that it does not contain any NNI ports with an NNI-connection to the network domain with the second endpoint, that unvisited network domain is marked as a visited domain in step 414 and the method loops back to step 410 to analyze the NNI ports of another unvisited domain.

Referring again to FIG. 3A, after E2E service has been decomposed to multiple network domains (subservices), the method continues to step 308, wherein the orchestration engine 106 (FIG. 1) sends a path computation request to each of the network domain controllers 124A-Z (FIG. 1) of the network domains 122A-Z (FIG. 1), via the domain adaptors 205A-Z of the orchestration engine 106.

In response to path computation request made by the orchestration engine 106 (FIG. 1) in step 308, the network domain controllers 124A-Z of the network domains 122A-Z (FIG. 1) each returns a list of paths to the orchestration engine 106 (via the domain adaptors 205A-Z of FIG. 1) for their respective subservice(s) of the requested E2E service. Then, in step 310 of FIG. 3A, the bandwidth calculator component 202 (FIG. 2) of the orchestration engine 106 (FIG. 1) performs a feasibility check to verify the availability of bandwidth for each path in each list of paths, according to a time aware service request verification method. The time aware service request verification method utilizes the path computation engine of each network domain controller 124A-Z. In particular, when the bandwidth calculator 202 executes the time aware service request verification method, it sends a path computation request to each of the network domain controllers 124A-Z via the respective domain adaptors 205A-Z and determines the feasibility of the service request, based on the returned list of paths from each of the network domain controllers 124A-Z and information stored in the orchestrator databases (i.e., the service usage, network topology and resource and service reservation computer databases 110, 112, and 114), which include the time aware service and resource management information. To implement this method, service reservation computer database 114 is designed to include service request start times/end times, bandwidth profiles, and endpoints. Each entry of the service reservation computer database 114 is associated with network topology and resources computer database 112 to describe the resource reservation/utilization rates across the time domain. The bandwidth calculator component 202 of the orchestration engine 106 utilizes the service usage, network topology and resource and service reservation computer databases 110, 112, and 114 and their relationships to verify the availability of the calculated path during the requested period.

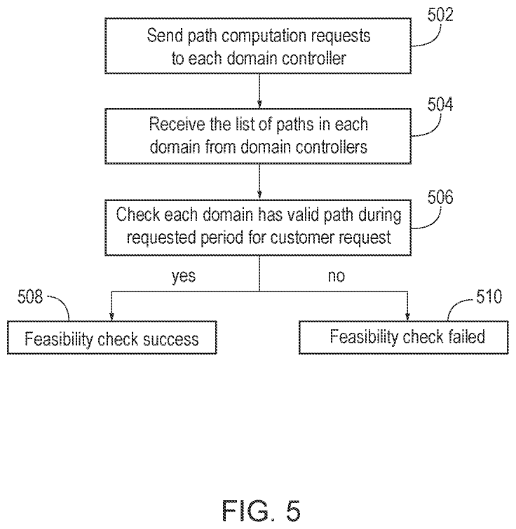

FIG. 5 is a flow chart that depicts the time aware service request verification method performed by the bandwidth calculator component 202 of the orchestration engine 106 according to an exemplary embodiment of the disclosure. In step 502, the subservice requests are sent by the domain adaptors 205A-Z of the orchestration engine 106 to their designated network domain via its network domain controller 124A-Z for a path computation request. Each subservice request includes two interface endpoints across that network domain (e.g., edge points/NNI ports a1 and a2 in network domain 124A). In step 504, each of the network domain controllers 124A-Z returns a list of paths (e.g., the dotted lines connecting the network equipment boxes NE in each of the network domains 122A-Z in FIG. 1) to the bandwidth calculator component 202 via the domain adaptors 205A-Z, which lists of paths interconnect the two interface endpoints. In step 506, the bandwidth calculator component 202 utilizes the service usage, network topology and resource and service reservation computer databases 110, 112, and 114 of the orchestrator 102 and their relationships (e.g., how much bandwidth is utilized for the service and what links are used in the path, the used links on that path or route, the used bandwidth for the service on each link, the available bandwidth remaining on each link, etc.) to verify the availability of the calculated path during the requested period, and checks the feasibility (i.e., the availability of bandwidth) of the customer request across the network domains 122A-Z. More specifically, for each network domain 122A-Z, the bandwidth calculator 202 selects a path from the list of paths that connect the two interface endpoints. Any desired path selection policy method can be used for selecting the path from the list of paths returned by the network domain controller (i.e. minimum hops, random, sequential, etc). When a path is selected a list of activated/reserved services assigned on the path is retrieved from the service usage, network topology and resource and service reservation computer databases 110, 112, and 114 of the orchestrator 102 in the selected network domain 122A-Z. From the returned paths for each network domain 122A-Z, the services running on that network domain during the same period are compared with the subservice(s) of the E2E service request for that network domain. All the links in a path are evaluated to determine if there are any links that do not have available bandwidth during the requested period. If the path has availability, the feasibility check is considered a success and the path is added to an output path in step 508 and the method moves to the next network domain 122A-Z. If any of the links has no availability during the requested time, the path is considered invalid for the request, so another path is selected from list of paths returned by the network domain controller 124A-Z of the selected network domain 122A-Z. If there is no valid path in the list of paths in the selected network domain A-Z, the feasibility check in the selected network domain 122A-Z is considered a failure and the feasibility check process is terminated for that network domain in step 510, and therefore, the E2E service is not possible.

Referring again to FIG. 3A, if all the subservices of the customer E2E request are feasible to perform, in step 312, the circuit builder 203 (FIG. 2) of the orchestration engine 106 (FIG. 1) designs the E2E service circuit based on the available paths in the network domains 122A-Z (FIG. 1).

Referring now to FIG. 3B, in step 314, the orchestration engine 106 (FIG. 1) determines whether the E2E service request is for a future time. If the E2E service request is determined by the orchestration engine 106 (FIG. 1) to be for a future time, the method flows to step 316, wherein the orchestration engine 106 (FIG. 1) updates the data in the service reservation computer database 114 (FIG. 1) and schedules the E2E service through the scheduler 116 (FIG. 1). On the date and at the time the E2E service is scheduled to proceed, in step 318 of FIG. 3B, the scheduler 116 causes the service management component 204 (FIG. 2) of the orchestration engine 106 (FIG. 1), to commence provisioning of the requested E2E service through the network domain controllers 124A-Z (FIG. 1) of the network domains 122A-Z (FIG. 1), via the domain adaptors 205A-Z (FIG. 2).

If, however, the orchestration engine 106 (FIG. 1) determines that the E2E service request is for an immediate time in step 314 of FIG. 3B, the method flows directly to step 318 of FIG. 3B, wherein the service management component 204 (FIG. 2) of the orchestration engine 106 (FIG. 1) commences provisioning of the requested E2E service through the network domain controllers 124A-Z (FIG. 1) of the network domains 122A-Z (FIG. 1), via the respective network domain adaptors 205A-Z (FIG. 2).

Returning to step 304 of FIG. 3A, if the E2E service is not across all the network domains 122A-Z (FIG. 1) and instead is only across one of the network domains 122A-Z, then the method flows to step 308 of FIG. 3A, wherein the orchestration engine 106 (FIG. 1) sends a path computation request only to the network domain controller 124A-Z (FIG. 1) of that network domain 122A-Z (FIG. 1) via the corresponding network domain adaptor 205A-Z (FIG. 2).

In response to path computation request made by the orchestration engine 106 in step 308, the network domain 122A-Z (FIG. 1) upon which the E2E service is across, returns a list of paths to the orchestration engine 106 (FIG. 1) via the corresponding network domain adaptor 205A-Z (FIG. 2). Then, in step 310 of FIG. 3A, the bandwidth calculator component 202 (FIG. 2) of the orchestration engine 106 (FIG. 1) performs a feasibility check to verify the availability of bandwidth for each path in the list of paths returned by the network domain 122A-Z (FIG. 1) upon which the E2E service is across, according to the method of FIG. 5, to determine if the E2E service request is feasible.

If the E2E service request is feasible to perform, in step 312 of FIG. 3A, the circuit builder 203 (FIG. 2) of the orchestration engine 106 (FIG. 1) designs the E2E service circuit based on the available paths in the network domain 122A-Z upon which the E2E service is across.

Referring again to FIG. 3B, in step 314, the orchestration engine 106 (FIG. 1) determines whether the E2E service request is for a future time. If the E2E service request is determined by the orchestration engine 106 (FIG. 1) to be for a future time, the method flows to step 316 of FIG. 3B, wherein the orchestration engine 106 (FIG. 1) updates the data in the service reservation computer database 114 (FIG. 1) and schedules the E2E service through the scheduler 116 (FIG. 1). On the date and at the time the E2E service is scheduled to proceed, in step 318 of FIG. 3B, the scheduler 116 causes the service management component 204 (FIG. 2) of the orchestration engine 106 (FIG. 1) to commence provisioning of the requested E2E service through the network domain controller 124A-Z (FIG. 1) of the network domain 122A-Z (FIG. 1) upon which the E2E service is across, via the corresponding network domain adaptor 205A-Z (FIG. 2).

If, however, the orchestration engine 106 (FIG. 1) determines that the E2E service request is for an immediate time in step 314 of FIG. 3B, the method flows directly to step 318 of FIG. 3B, wherein the service management component 204 (FIG. 2) of the orchestration engine 106 (FIG. 1) commence provisioning of the requested E2E service through the network domain controller 124A-Z (FIG. 1) of the network domain 122 A-Z (FIG. 1) upon which the E2E service is across, via the corresponding network domain adaptor 205A-Z (FIG. 2)

It should be understood that the invention is not limited to the embodiments illustrated and described herein. Rather, the appended claims should be construed broadly to include other variants and embodiments of the invention, which may be made by those skilled in the art without departing from the scope and range of equivalents of the invention. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method for time aware end-to-end (E2E) service orchestration across a plurality of network domains of a communication network, comprising:
receiving at an orchestrator computing device, a request for a E2E service at a requested time;
determining with the orchestrator computing device, whether the E2E service is across the plurality of network domains;
if the E2E service is across more than one of the plurality of network domains, decomposing with the orchestrator computing device, the E2E service into a plurality of subservices, the plurality of subservices designated for the more than one of the plurality of network domains;
determining in a time aware manner with the orchestrator computing device, the availability of bandwidth for each of one or more paths that have been calculated for each of the subservice paths across their designated network domains, at the requested time;
if bandwidth is available for one of the one or more service paths at the requested time in each of the network domains having a subservice designated thereto, designing with the orchestrator computing device a E2E circuit path based on the available one or more service paths in each of the network domains having a subservice designated thereto; and
provisioning, with the domain controller computing devices of the network domains having the subservices designated thereto, the plurality of subservices of the E2E service, in response to a provisioning request from the orchestrator computing device.

2. The method of claim 1, wherein the determining of whether the E2E service is across the plurality of network domains comprises:
finding one of the plurality of network domains;
determining whether a first endpoint of the E2E service belongs to the found one of the plurality of network domains;
determining whether a second endpoint of the E2E service belongs to the found one of the plurality of network domains; and
if the first endpoint belongs to the found one of the plurality of network domains and the second endpoint does not belong to the found one of the plurality of network domains, then the E2E service is across the plurality of network domains.

3. The method of claim 1, wherein a record of network-to-network interface (NNI) ports of the plurality of network domains is stored in a database, and wherein the decomposing of the E2E service comprises:
a. determining for each of the NNI ports of a selected one of network domains, whether there is an NNI-connection that connects that NNI port to another one of the network domains;
b. if there is an NNI-connection that connects that NNI port of the selected one of the network domains to an NNI port of the unvisited network domain, classifying that NNI-connection as belonging to E2E service path, wherein the network domains connected by the NNI-connection each perform a subservice of the E2E service; and
c. repeating a and b for each of the network domains.

4. The method of claim 1, further comprising requesting with the orchestrator computing device, that a domain controller computing device of each network domain of the plurality of network domains having a subservice designated thereto, perform the calculating of the one or more paths for that subservice across its designated network domain.

5. The method of claim 1, wherein the determining of the availability of bandwidth for each of the one or more paths comprises using service usage, network topology and resource, service reservation data, and their relationships to one another stored in at least one computer database to verify the availability of bandwidth for each of the one or more paths at the requested time.

6. The method of claim 1, wherein the determining of the availability of bandwidth for each of the one or more paths comprises for each of the designated network domains, selecting a path from the one or more paths associated therewith and comparing other services running on that designated network domain at the same time that the subservice is requested to be running on that network domain to determine if bandwidth is available for that subservice at the requested time, wherein data about the other services running on the designated network domains is obtained by the orchestrator computing device from at least one computer database.

7. The method of claim 1, wherein before provisioning the plurality of subservices, further comprising:
determining whether the E2E service is for a future time;
if the E2E service is for a future time, updating data in a service reservation computer database;
scheduling the E2E service through a scheduler; and
with the scheduler, causing the orchestrator computing device to request the provisioning of the plurality of subservices of the requested E2E service.

8. The method of claim 1, before provisioning the plurality of subservices, further comprising:
determining whether the E2E service is for a future time;
if the E2E service is for an immediate time, requesting the provisioning of the plurality of subservices of the requested E2E service.

9. The method of claim 1, wherein if the E2E service is across only one of the plurality of network domains:
determining in the time aware manner with the orchestrator computing device, the availability of bandwidth for each of one or more paths calculated for the E2E service across the only one of the plurality of network domains, at the requested time;
if bandwidth is available for one of the one or more service paths at the requested time in the only one of the plurality of network domains, designing with the orchestrator computing device a E2E circuit path based on the available one or more service paths in the only one of the plurality of network domains; and
provisioning, through the domain controller computing device of the only one of the plurality of network domains, the plurality of subservices of the E2E service in response to a request from the orchestrator computing device.

10. An orchestration system comprising:
a plurality of network domains of a communication network, each of the plurality of network domains have at least one network-to-network interface (NNI) port and a domain controller computing device, each of the domain controller computing devices configured for provisioning E2E services and subservices;
an orchestrator computing device for time aware end-to-end (E2E) service orchestration across the plurality of network domains;
the orchestrator computing device configured to:
receive a request for a E2E service at a requested time;
determine whether the E2E service is across the plurality of network domains;
decompose the E2E service into a plurality of subservices if the E2E service is across more than one of the plurality of network domains, the plurality of subservices designated for the more than one of the plurality of network domains;
determine in a time aware manner the availability of bandwidth for each of one or more paths that have been calculated for each of the subservice paths across their designated network domains, at the requested time;
design a E2E circuit path if bandwidth is available for one of the one or more service paths at the requested time in each of the network domains having a subservice designated thereto, the E2E circuit path based on the available one or more service paths in each of the network domains having a subservice designated thereto; and
request the domain controller computing devices of the network domains having the subservices designated thereto, provision the plurality of subservices of the E2E service in response.

11. The system of claim 10, wherein the orchestration computing device is configured to determine whether the E2E service is across the plurality of network domains by:
finding one of the plurality of network domains;
determining whether a first endpoint of the E2E service belongs to the found one of the plurality of network domains;
determining whether a second endpoint of the E2E service belongs to the found one of the plurality of network domains; and
if the first endpoint belongs to the found one of the plurality of network domains and the second endpoint does not belong to the found one of the plurality of network domains, then the E2E service is across the plurality of network domains.

12. The system of claim 10, wherein the orchestrator computing device includes a database for storing a record of the network-to-network interface (NNI) ports of the plurality of network domains, and wherein the orchestrator computing device is configured to decompose the E2E service by:
a. determining for each of the NNI ports of a selected one of network domains, whether there is an NNI-connection that connects that NNI port to another one of the network domains;
b. if there is an NNI-connection that connects that NNI port of the selected one of the network domains to an NNI port of the unselected network domain, classifying that NNI-connection as belonging to both network domains, wherein the network domains connected by the NNI-connection each perform a subservice of the E2E service; and
c. repeating a and b for each of the network domains.

13. The system of claim 10, wherein the orchestrator computing device is configured to request that the domain controller computing device of each network domain of the plurality of network domains having a subservice designated thereto, perform the calculation of the one or more paths for that subservice across its designated network domain.

14. The system of claim 10, wherein the orchestrator computing device includes at least one database for storing service usage, network topology and resource, service reservation data, and their relationships to one another, wherein the orchestrator computing device is configured to determine the availability of bandwidth for each of the one or more paths comprises using the service usage, network topology and resource, service reservation data, and their relationships to one another stored in the at least one computer database, to verify the availability of bandwidth for each of the one or more paths at the requested time.

15. The system of claim 10, wherein the orchestrator computing device includes at least one database for storing data about services of other requests running on the designated network domains, wherein the orchestrator computing device is configured to determine the availability of bandwidth for each of the one or more paths for each of the designated network domains by selecting a path from the one or more paths associated therewith and comparing the services of the other requests running on that designated network domain at the same time that the subservice is requested to be running on that network domain to determine if bandwidth is available for that subservice at the requested time.

16. The system of claim 10, wherein the orchestrator computing device includes a service registration database and a scheduler, wherein before provisioning the plurality of subservices, the orchestrator computing device is configured to:
determine whether the E2E service is for a future time;
if the E2E service is for a future time, update data in the service reservation computer database; and
schedule the E2E service through a scheduler;
wherein the scheduler is configured to cause the orchestrator computing device to request the provisioning of the plurality of subservices of the requested E2E service.

17. The system of claim 10, before provisioning the plurality of subservices, the orchestrator computing device is configured to:
determine whether the E2E service is for a future time; and
if the E2E service is for an immediate time, request that the domain controller computing devices provision the plurality of subservices of the requested E2E service.

18. The system of claim 10, wherein if the E2E service is across only one of the plurality of network domains, the orchestrator computing device is configured to:
determine in the time aware manner, the availability of bandwidth for each of one or more paths calculated for the E2E service across the only one of the plurality of network domains, at the requested time; and
if bandwidth is available for one of the one or more service paths at the requested time in the only one of the plurality of network domains, design an E2E circuit path based on the available one or more service paths in the only one of the plurality of network domains;
wherein the domain controller computing device of the only one of the plurality of network domains. provisions the plurality of subservices of the E2E service in response to a request from the orchestrator computing device.
